(19) United States
(12) Patent Application Publication
(10) Pub. No.: US 2002/0088816 A1
(43) Pub. Date: Jul. 11, 2002

(54) Method and system for controlling dispensing machines using smart card technology

(75) Inventors: Joseph Vaitkus, Roslyn, NY (US); Richard Moore, Westbury, NY (US)

Correspondence Address: DARBY & DARBY P.C., 805 Third Avenue, New York, NY, 10022, US

(73) Assignee: Cecilware Corporation

(21) Appl. No.: 09/960,222

(22) Filed: Sep. 21, 2001

Related U.S. Application Data
(60) Provisional application No. 60/234,550, filed on Sep. 22, 2000.

(51) Int. Cl. G07F 11/00

(52) U.S. Cl. 221/9

(57) ABSTRACT

A method and system for using an identification care to limit the use of a dispensing machine to a particular brand i dispensed product are provided

### CROSS-REFERENCE TO RELATED APPLICATION

This application claims the benefit of U. S. provisional application Ser. No. 60/234,550, filed Sep. 22, 2000, which is hereby incorporated by reference in its entirety.

### FIELD OF THE INVENTION

The invention refers to a method and system for using an identification card to limit the use of a dispensing machine to a particular brand of dispensed material.

### BACKGROUND OF THE INVENTION

In practice, the benefits of this system are realized when applied to a percolated coffee dispenser, also known as a coffee brewer. Producers of dispensable goods, such as coffee beans, seek to gain a strong market share through a reliable customer base. One method coffee bean producers attempt to retain customers is through a bargained exchange. In this exchange, customers agree to purchase all the coffee beans they require from the producers while the producers supply coffee brewing machines to these customers at a nominal cost. Since the nominal cost for these brewing machines represents a fraction of the purchase cost, the producers stand to lose much of their investment if the customers later purchase their coffee requirements elsewhere. Until now, these consumers could purchase coffee beans from other sources, without interference from the bean producer. There currently is no method whereby the bean producer could either control where these consumers purchased their coffee beans or the consumer's use of the distributed coffee brewing machines.

### SUMMARY

According to one exemplary embodiment, machines for brewing coffee beans are adapted so that the bean producers may control the use thereof.

The foregoing advantage is obtained by the use of an identification card for identifying, within a bag of coffee: (1) the brand of coffee used; (2) the identity of the particular bag; and (3) the amount of coffee remaining within the bag. In another aspect, a machine for dispensing brewed coffee is provided and a controlling device for reading the identification card is provided and permits operation of the dispensing machine only if: (1) the coffee provided is produced by a certain coffee producer; and (2) if there is coffee remaining within the coffee bag as indicated by the identification card.

This arrangement guarantees that customers who purchase their brewing machines from the producers may only brew coffee they obtain from the entity providing the brewing machine.

Still other advantages of the present arrangement will become readily apparent to those skilled in this art from the following detailed description, wherein is shown and described only one exemplary embodiment, simply by way of illustration of the best mode contemplated for carrying out the invention. As will be realized, the invention is capable of other and different embodiments, and its several details are capable of modifications in various respects, all without departing from the invention. Accordingly, the drawing and description are to be regarded as illustrative in nature, and not as restrictive.

### BRIEF DESCRIPTION OF THE DRAWINGS

FIG. 1 is a perspective view of a dispensing unit according to one exemplary embodiment; and

FIG. 2 is a schematic view of an exemplary control unit for use with the dispensing unit of FIG. 1.

### DETAILED DESCRIPTION OF PREFERRED EMBODIMENTS

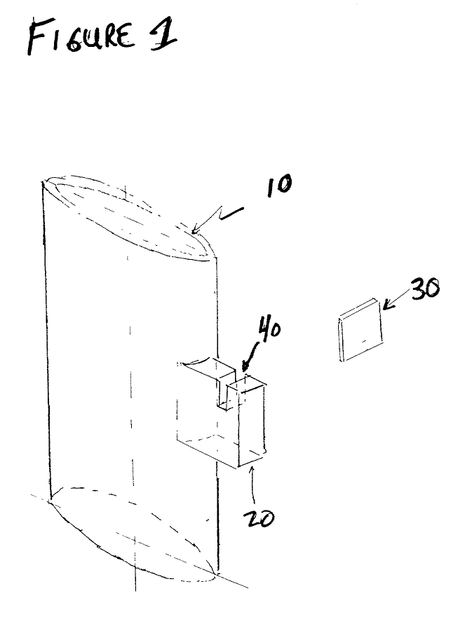

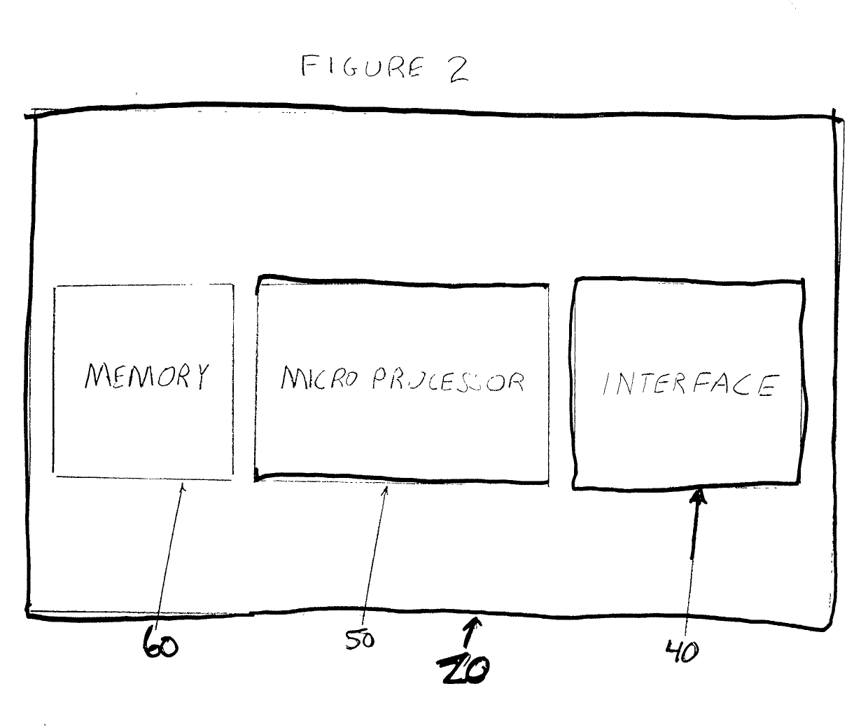

Referring now to FIGS. 1-2, one exemplary embodiment of the invention comprises a dispensing unit (10) and a device (20) for controlling access to the dispensing unit (10). The controlling device (20) is integrally connected to the dispensing unit (10) or may be in a remote location so long as the controlling device (20) is in communication with the dispensing unit (10). The invention further comprises a portable identification unit or card (30), in the consumer's possession. The controlling device (20) comprises an interface (40) for enabling communication between the controlling device (20) and the identification unit (30). The identification unit (30) communicates with the controlling device (20) so that the dispensing unit (10) will either operate or not.

In the one exemplary embodiment, the dispensing unit (10) is that which, for example, dispenses brewed coffee, obtained by a customer from a particular coffee distributor. The identification unit (30) is, for example, a disposable identification card obtained by the customer from the coffee distributor. The identification card (30) is, for example, attached to each bag of coffee beans which the coffee distributor sells. Each time the consumer purchases coffee beans from the distributor, they receive a new card (30).

The identification card (30) contains such information as an identifying serial number, an indicator that authenticates that the distributor sold the beans, and an indicator of the quantity of beans within the bag. The quantity indicator is in the form of, for example, total volume of beans within the bag or total servings per bean bag. The interface (40) operates to extract information from the identification card (30). Therefore, the information is embedded on the identification card (30) so that the interface (40) can scan and analyze the information therefrom.

When the customer attempts to brew coffee beans in the coffee brewer (10) from a fresh bag of beans, the customer causes communication between the interface (40) of the control unit (20) and the identification card (30). In the preferred embodiment, the interface (40) is, for example an interactive type, such as a machine for reading magnetic stripe cards. The identification card (30) stores the information in a read-only magnetic format and the communication between the interface (40) and the identification card (30) occurs using standard communication techniques, as is known in the art. In an alternative embodiment, the interface (40) need not physically interface with the card (30). For example, the interface (40) may be an instrument, e.g., a reader, for reading a bar code or a device for reading information contained on a transponder, such as systems currently used to electronically pay a toll machine by driving underneath a device which reads information from a transponder in the vehicle. In yet another embodiment, identification card (30) is re-writable and the controlling device (20) re-programs the card (30) such that it can not be re-used without authorization. The controlling device (20) either itself or in combination with other components is capable of rewriting the card (30). In this embodiment, each time the consumer finishes a supply of beans, the distributor programs in a new serial number along with a new quantity amount. The new quantity amount corresponds to the new quantity which the consumer purchases from the distributor.

In the preferred embodiment, the control unit (20) includes a microprocessor (50) which analyzes the information encoded on the identification card (30), and memory (60) for storing information pertaining to the identification card (30) and instructions executed by the microprocessor (50). The microprocessor (50) authenticates the information pertaining to the producer of the beans. If the customer purchased the beans from an unauthorized distributor, the identification card (30) associated with the beans will not authenticate when the interface (40) communicates with the card (30), and the control unit (20) will fail to operate the brewer (10).

The microprocessor (50) may be in operative communication with a master control unit (not shown) which may be in communication with a number of controlling devices (20). For example, the distributor may have a single master control unit which communicates with a number of controlling devices (20) at a plurality of customer sites that may be remote from one another.

If the customer purchased the beans from the correct distributor, the microprocessor (50) will authenticate the information on the identification card (30). The microprocessor (50) further scans or otherwise reads the serial number on the card (30).

The microprocessor (50) compares the serial number on the card (30) with those stored in the memory (60). If the microprocessor (50) fails to recognize the serial number because, for example, the card (30) is new, the microprocessor (50) stores the serial number and the quantity information of the card (30) in the memory (60), and allows the customer to operate the brewer (10). In will be appreciated that the serial number may include a prefix or other code that identifies the card (30) as being from this distributor. Alternatively, there may be another identifying indicia stored on the card (30) which identifies the card (30) as being from the distributor. In this embodiment, f the microprocessor (50) is unable to confirm that the card (30) is from a particular distributor, the microprocessor (50) will not store any information in the memory (60).

Each time the customer uses the brewer (10), the microprocessor (50) stores in memory (60) how much quantity of coffee beans the customer uses. The measurement of the quantity is taken, for example, by a scale (not shown) located within the brewer and integrally connected to the microprocessor (50) or simply by a number of uses. The scale measures the mass of coffee beans used during a single operational cycle of the brewer (10). The microprocessor (50) retrieves from memory (60) the quantity information associated with the serial number for this bag of beans and subtracts the quantity which the customer then uses. The microprocessor (50) then replaces the quantity information previously stored in memory (50) with the new, smaller quantity. Ultimately, when the customer depletes the entire quantity of beans in a bag, the microprocessor (50) stores in memory (60) information which permanently disables the serial number associated with the bag of beans. This way, a customer may not re-use the same identification card (30) on, for example, a bag of beans purchased from an alternative distributor.

The card (30) may be provided with the bag in a number of manners. For example, the card (30) may only loosely be attached to the bag such that the user can remove and take the card (30) away from the bag in order to provide the proper communication between the interface (40) and the card (30). Alternatively, the card (30) may be attached to the bag, e.g., sewn in a pocket slot, and the user simply places the card (30) within reading distance of the interface (40) prior to the user filling the dispensing unit (10).

While, the dispensing unit (10) and the other components described hereinbefore have been described as being used in an assembly which disperses coffee beans, it will be appreciated that the dispensing unit (10) may be used in other settings, such as dispensing of soft drinks from a particular manufacture or distributor or any other product that is typically dispersed from a unit (10) which is provided by the same manufacturer or distributor.

1. A dispensing apparatus with a control system comprising:
a dispensing apparatus for dispensing a quantity of product;
a control device in operative communication with the dispensing apparatus for actuating the dispensing apparatus to disperse the quantity of product, the control device including an interface unit; and
an identification unit remote from the control device, the identification unit containing dispensing information including a first identifying indicia, a quantity indicator, and an indicator for authenticating a source of the product, wherein the interface unit reads the dispensing information from the identification unit and causes the actuation of the control device and dispensing of the product upon confirming that the source indicator and first identifying indicia are valid and that the quantity indicator is a positive value, whereby the dispensing apparatus dispenses the quantity of the product up to the positive value upon the confirmation.

2. The system of claim 1, wherein the product is coffee beans.

3. The system of claim 1, wherein the dispensing apparatus includes a section for holding the product.

4. The system of claim 1, wherein the control device is integrally connected to the dispensing apparatus.

5. The system of claim 1, wherein the control device includes a microprocessor for reading the dispensing information contained on the identification unit and a memory for storing the dispensing information.

6. The system of claim 1, wherein the interface unit is an interactive unit which reads the dispensing information stored in magnetic form on the identification unit.

7. The system of claim 1, wherein the interface unit is a scanner for reading the dispensing information which is stored as a bar code on the identification unit.

8. The system of claim 1, wherein the interface unit has a device for remotely reading the dispensing information stored on the identification unit.

9. The system of claim 1, wherein the identification unit is an identification card storing the dispensing information in a readable form.

10. The system of claim 1, wherein the identification unit stores dispensing information in a read-only magnetic form.

11. The system of claim 1, wherein the identification unit stores the dispensing information in a re-writable form.

12. The system of claim 1, wherein the first identifying indicia is a serial number for uniquely identifying the identification unit.

13. The system of claim 1, wherein the dispensing apparatus includes a device for measuring a quantity of product dispersed from the dispensing apparatus, the measuring device in communication with the control device.

14. The system of claim 5, wherein the control device confirms the validity of the source indicator by confirming that the source of the dispensing apparatus and the source of the product are the same and the control device confirms the validity of the first identifying indicia with identifying indicia stored in the memory.

15. The system of claim 5, wherein the microprocessor is configured such that if the microprocessor determines that the source indicator is valid and the microprocessor fails to recognize the first identifying indicia, the first identifying indicia and quantity indicator are stored in memory.

16. The system of claim 5, wherein the microprocessor stores in memory how much quantity of product is dispensed through the dispensing apparatus.

17. The system of claim 5, wherein the microprocessor is configured such that it subtracts the dispersed quantity from the quantity indicator stored in memory to arrive at an updated quantity indicator that is stored in memory replacing any previously stored quantity indicator.

18. The system of claim 1, wherein the control device instructs the dispensing unit to be disabled upon the occurrence of one of the first identifying indicator is invalid and the quantity indicator representing the quantity of product remaining for dispensing has a value of 0.

19. A dispensing apparatus with a control system comprising:
a dispensing apparatus for dispensing a quantity of product;
a control device in operative communication with the dispensing apparatus for actuating the dispensing apparatus to disperse the quantity of product, the control device including an interface unit; and
an identification unit remote from the control device, the identification unit containing dispensing information including a unique serial number and a quantity indicator representing a current quantity of the product, wherein the interface unit reads the dispensing information from the identification unit and causes the actuation of the control device and dispensing of the product upon confirming that the serial number is valid and that the quantity indicator is a positive value, whereby the dispensing apparatus dispenses the quantity of the product up to the positive value upon the confirmation.

20. A method of actuating a dispensing apparatus configured to disperse a quantity of product, the dispensing apparatus having a control device in operative communication with the dispensing apparatus for actuating the dispensing apparatus to disperse the quantity of product, the control device including an interface unit, the method comprising the steps of:
providing an identification unit separate and remote from the control device, the identification unit having dispensing information stored thereon, the dispensing information including a unique serial number and a quantity indicator representing a current quantity of product;
placing the identification unit within a distance of the interface unit such that the interface unit reads the dispensing information from the identification unit; and
actuating the dispensing apparatus to dispense the quantity of product upon the control device confirming that the serial number is valid and that quantity indicator is a positive value, the dispensing apparatus dispenses an amount of product up to the positive value.
